(19) United States
(12) Patent Application Publication
(10) Pub. No.: US 2007/0228962 A1
(43) Pub. Date: Oct. 4, 2007

(54) Panel for plasma display, method of manufacturing the same, plasma display panel including the panel, and method of manufacturing the plasma display panel

(76) Inventors: Seok-Gyun Woo, Suwon-si (KR); Won-Ju Yi, Suwon-si (KR); Kyoung-Doo Kang, Suwon-si (KR); Ho-Young Ahn, Suwon-si (KR); Soo-Ho Park, Suwon-si (KR); Dong-Young Lee, Suwon-si (KR); Jae-Ik Kwon, Suwon-si (KR); Im-Soo Shim, Suwon-si (KR)

Correspondence Address: Robert E. Bushnell, Suite 300, 1522 K Street, N.W., Washington, DC, 20005-1202, US

(21) Appl. No.: 11/713,047

(22) Filed: Mar. 2, 2007

(30) Foreign Application Priority Data
Apr. 3, 2006 (KR) 10-2006-0030134

(51) Int. Cl. H01J 17/49; B05D 5/12; H01J 9/24

(52) U.S. Cl. 313/582; 313/586; 427/58; 445/24

(57) ABSTRACT

In a panel for plasma display, a method of manufacturing the same, a plasma display panel including the panel, and a method of manufacturing the plasma display panel, the panel for plasma display includes a substrate which is flexible, and a plurality of electrodes arranged on at least one surface of the substrate.

### CLAIM OF PRIORITY

This application makes reference to, incorporates the same herein, and claims all benefits accruing under 35 U.S.C.§119 from an application for PANEL FOR PLASMA DISPLAY, METHOD OF MANUFACTURING THE SAME, PLASMA DISPLAY PANEL COMPRISING THE PANEL, AND METHOD OF MANUFACTURING THE PANEL earlier filed in the Korean Intellectual Property Office on the 3^{rd} of Apr. 2006 and there duly assigned Ser. No. 10-2006-0030134.

### BACKGROUND OF THE INVENTION

1. Technical Field

The present invention relates to a panel for plasma display, a method of manufacturing the same, a plasma display panel including the panel, and a method of manufacturing the plasma display panel.

2. Related Art

Plasma display panels (PDP), displaying images using a gas discharge phenomenon, provide large screens and certain advantages, such as a high-quality image display, a very thin and light design, and a wide-range viewing angle. PDPs have attracted considerable attention as the most promising large-size flat display panels, because they can be manufactured in a simplified manner and can be easily manufactured in a large size compared to other flat display panels.

Generally, PDPs display images by discharging gas filled in many cells formed between two facing substrates to generate ultraviolet (UV) rays and by exciting phosphor films formed within the cells with the UV rays.

On each of the two substrates, there are formed not only a plurality of electrodes but also a dielectric layer which covers the electrodes, barrier ribs which partition the space between the two substrates into a plurality of discharge cells, phosphor layers which emit visible light, and other elements

Each of the two substrates is much thicker than the other elements. For example, each of the two substrates is about 2.8 mm thick, whereas the sum of the thicknesses of the other elements, including an electrode, a dielectric layer and a barrier rib, is only about 200 μm. That is, the thickness of each substrate is about 28 times thicker than the sum of the thicknesses of the other elements. As described above, since each substrate of a PDP is very thicker than the other elements, a percentage of the light emitted from the phosphor layers occupied by light which passes through the substrate is reduced. This leads to degradation of the luminous efficiency.

In addition, each substrate of a PDP is greatly heavier than the other elements. Hence, handling the substrate in order to manufacture the PDP is not easy, and the substrate is highly likely to be deformed or destroyed. Furthermore, the weight of a frame which is combined with the PDP, including the heavy substrate, in order to hold the PDP is accordingly increased. Hence, a plasma display apparatus is so heavy that the manufacture, installation and use thereof is burdensome, and it is highly likely to be damaged. As PDPs become larger, these problems become worse.

Since each substrate of a PDP is made of a non-flexible material, such as glass, it is not bent. This characteristic of the substrate prevents the PDP having the substrate from being applied to a technical field which demands flexible panels. Thus, the application of PDPs is limited.

### SUMMARY OF THE INVENTION

The present invention provides a panel for plasma display which is flexible, a method of manufacturing the flexible panel, a plasma display panel including the flexible panel, and a method of manufacturing the plasma display panel.

According to an aspect of the present invention, a panel for plasma display includes a substrate which is flexible, and a plurality of electrodes arranged on at least one surface of the substrate.

According to another aspect of the present invention, a method of manufacturing a panel for plasma display includes the steps of preparing for a substrate which is flexible and arranging a plurality of electrodes on at least one surface of the substrate.

According to another aspect of the present invention, a plasma display panel includes a first substrate which is flexible, a plurality of first electrodes arranged on one surface of the first substrate, an insulation layer with which the first electrodes are covered, and a second substrate facing the surface of the first substrate on which the first electrodes are arranged.

According to another aspect of the present invention, a plasma display panel includes: a first substrate which is flexible; a plurality of first electrodes arranged on one surface of the first substrate; a plurality of second electrodes arranged on the other surface of the first substrate; a first insulation layer with which the first electrodes are covered; a second insulation layer with which the second electrodes are covered; and a second substrate and a third substrate facing each other and between which the first substrate, the first and second electrodes, and the first and second insulation layers are located, wherein apertures are formed in portions of the first substrate which are not covered with the first and second electrodes.

According to another aspect of the present invention, a method of manufacturing a plasma display panel includes the steps of preparing for a first substrate which is flexible, arranging a plurality of electrodes on at least one surface of the first substrate, forming an insulation layer with which the electrodes are covered, and arranging at least one second substrate directly over the surface of the first substrate on which the electrodes are formed.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partial cross-section view of a panel for plasma display according to an embodiment of the present invention;

FIG. 2 is a partial exploded cross-section view of a panel for plasma display according to another embodiment of the present invention;

FIGS. 3A thru 3H are cross-sectional views illustrating a method of manufacturing the panel for plasma display shown in FIG. 2;

FIG. 4 is a partial cross-section view of a plasma display panel according to an embodiment of the present invention;

FIG. 5 is a partial cross-section view of a plasma display panel according to another embodiment of the present invention; and

FIGS. 6A thru 6I are cross-sectional views illustrating a method of manufacturing the plasma display panel shown in FIG. 5.

### DETAILED DESCRIPTION OF THE INVENTION

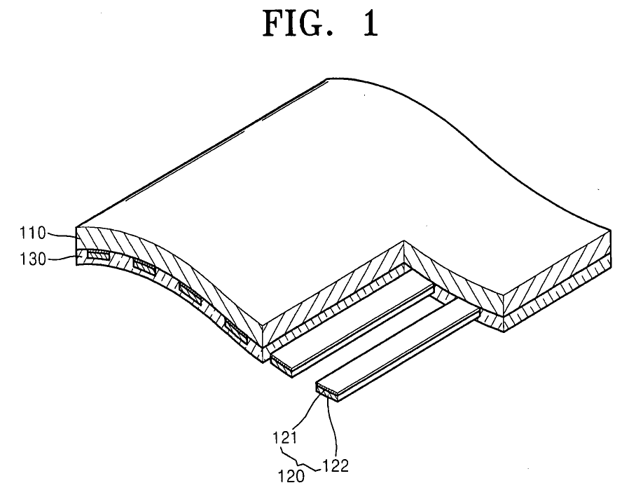

FIG. 1 is a partial cross-section view of a panel for plasma display according to an embodiment of the present invention.

The panel includes a substrate 110, a plurality of electrodes 120, and an insulation layer 130. The substrate 110 is a flexible flat plate. To be flexible, the substrate 110 may be formed of a material including at least one of polyethersulfone resin and polyimide. Alternatively, the substrate 110 may be formed of a material including an organic material. Hence, the panel for plasma display, including the flexible substrate 110, can be applied to various fields compared to a panel for plasma display which includes a non-flexible substrate.

The thickness of the substrate 110 is less than or equal to 2.8 mm. When the thickness of the substrate 110 exceeds 2.8 mm, it is difficult to secure flexibility. Due to the small thickness of the substrate 110, the weight thereof is also small, and thus the weight of the panel is also small. Accordingly, it is not difficult to handle the substrate 110 during the manufacture and use of the panel.

The substrate 110 transmits light. To achieve this, the substrate 110 is made of polyethersulfone resin, polyimide, or the like. When the substrate 110 is able to transmit light, the panel including the substrate 110 can be used as a front substrate which transmits the light emitted by discharge in a plasma display panel.

The electrodes 120 are arranged on one surface of the substrate 110. As illustrated in FIG. 1, the electrodes 120 are arranged in a striped pattern. However, depending on the type of plasma display panel, the electrodes 120 may be arranged in various other patterns, such as a matrix pattern.

Each of the electrodes 120 includes a plated seed film 121 formed on the substrate 110 and a plated layer 122 formed on the plated seed film 121, the plated layer 122 including a material to form the electrodes 120. The plated seed film 121, serving as a seed of the formation of the plated layer 122 on the substrate 110, may be formed of a material which can be easily coated on the flexible substrate 110, such as, a polyethersulfone resin or polyimide film. The plated layer 122 is formed of the material of the electrodes 120, such as, a material with which the plated seed film 121 can be easily plated. When each of the electrodes 120 is made up of the plated seed film 121 and the plated layer 122 formed on the plated seed film 121 as described above, the electrodes 120 can be easily formed on the flexible substrate 110.

The plated seed film 121 and the plated layer 122 may be an electroless seed film and an electroless plated layer, respectively. In this case, the electrodes 120 can be more easily formed than when the electrodes 120 are made up of an electrolytic seed film 121 and an electrolytic plated layer 122.

The electrodes 120 are covered with the insulation layer 130. The insulation layer 130 may be formed either on the entire surface of the substrate 110 or on a part of the surface of the substrate 110 which corresponds to the electrodes 120.

Although the insulation layer 130 may be formed of various materials, the insulation layer 130 may be formed of a material as flexible as the material of the substrate 110, for example, polyethersulfone resin or polyimide. When the insulation layer 130 is formed of a flexible material as described above, the flexibility of the panel for plasma display increases because both the substrate 110 and the insulation layer 130 formed thereon are flexible.

Since the panel for plasma display having this structure is flexible, it operates even when it is bent as illustrated in FIG. 1.

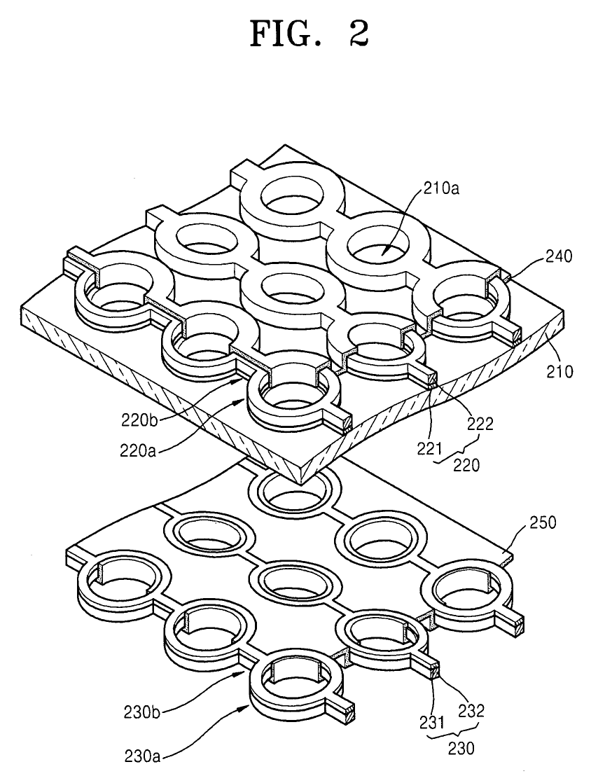

FIG.2 is a partial exploded cross-section view of a panel for plasma display according to another embodiment of the present invention.

This panel for plasma display includes a substrate 210, a plurality of first electrodes 220, a plurality of second electrodes 230, a first insulation layer 240, and a second insulation layer 250.

The substrate 210 is a flexible flat plate. Similar to the substrate 110 of FIG. 1, the substrate 210 may be formed either of a material including at least one of polyethersulfone resin and polyimide, or of a material including an organic material. The thickness of the substrate 210 is less than or equal to 2.8 mm, similar to the substrate 110 of FIG. 1.

The substrate 210 may transmit light. In this case, light generated by discharge generated between the first electrodes 220 and second electrodes 230 formed on both sides of the substrate 210 is emitted to the outside of the substrate 210 via apertures 210a formed on the discharge path between the first electrodes 220 and second electrodes 230. The light is also emitted through the substrate 210. Thus, the luminous efficiency is improved.

The substrate 210 may not transmit light. In this case, the light generated by discharge is emitted to the outside of the substrate 210 only via the apertures 210a of the substrate 210.

The apertures 210a are formed in parts of the substrate 210 which are not covered with the first electrodes 220 and second electrodes 230. As illustrated in FIG. 2, the apertures 210a are formed in areas of the substrate 210 which are surrounded by circular parts of the first electrodes 220. The shapes of the apertures 210a are not limited to circles. The apertures 210a may have various shapes, such as the shape of a polygon (e.g., a rectangle) or an oval, depending on the shapes of areas of the substrate 210 which are surrounded by the electrodes 210a. The apertures 210a define spaces in which discharge can occur between the first electrodes 220 and second electrodes 230.

The first electrodes 220 and the second electrodes 230 are arranged on both sides of the substrate 210. As illustrated in FIG. 2, the first electrodes 220 include discharge parts 220a which contribute to discharge, and connecting parts 220b which connect the discharge parts 220a to each other. Each of the discharge parts 220a may have a shape which completely surrounds a certain area, for example, a circle as illustrated in FIG. 2. However, the shapes of the discharge parts 220a are not limited to circles, but maybe various other shapes, such as that os a polygon (e.g., a rectangle) or an oval. Each of the discharge parts 220a may have a shape which surrounds only a part of a certain area, for example, a semicircular shape. Each of the connecting parts 220b has a shape which connects the discharge parts 220a, for example, a rectilinear shape as illustrated in FIG. 2. However, the connecting parts 220b may have curvilinear shapes or bent line shapes.

The first electrodes 220 extend across the substrate 210 and are substantially parallel to each other. The first electrodes 220 are arranged on the substrate 210 so that areas of the substrate 210 which are defined by the discharge parts 220a correspond to the apertures 210a of the substrate 210.

Each of the first electrodes 220 may be a single layer including a conductive material. However, as illustrated in FIG. 2, each of the first electrodes 220 includes a first plated seed film 221 formed on the substrate 210 and a first plated layer 222 formed on the first plated seed film 221, the plated layer 222 including a material used to form the first electrodes 220.

The first plated seed film 221, serving as a seed of the formation of the first plated layer 222 on the substrate 210, may be formed of a material which can be easily coated on the flexible substrate 210, such as, a polyethersulfone resin or polyimide film.

The first plated layer 222 is formed of the material of the first electrodes 220, such as a material with which the first plated seed film 221 can be easily plated. When each of the electrodes 220 is made up of the first plated seed film 221 and the first plated layer 222 formed on the first plated seed film 221 as described above, the first electrodes 220 can be easily formed on the flexible substrate 210.

The first plated seed film 221 and the first plated layer 222 may be an electroless seed film and an electroless plated layer, respectively. In this case, the first electrodes 220 can be more easily formed than when the first electrodes 220 are made up of an electrolytic first seed film 221 and an electrolytic first plated layer 222.

The first electrodes 220 are covered with the first insulation layer 240. The first insulation layer 240 may be formed either on the entire surface of the substrate 210 except for the apertures 210a while covering the first electrodes 220, or on parts of the surface of the substrate 210 which correspond to the first electrodes 220.

The first insulation layer 240 may be formed of various insulation materials, for example, a flexible insulation material such as polyethersulfone resin or polyimide. When the first insulation layer 240 is formed of an insulation and flexible material, that is, the material used to form the substrate 210, as described above, the flexibility of the panel for plasma display of FIG. 2 increases. Moreover, since the first insulation layer 240 is formed of the material used to form the substrate 210, the flexibility of the first insulation layer 240 is consistent with that of the substrate 210. Accordingly, portions of the first insulation layer 240 and the substrate 210 which contact each other are prevented from cracking.

The second electrodes 230 are arranged on a side opposite to the side of the substrate 210 on which the first electrodes 220 are arranged. Similar to the first electrodes 220, the second electrodes 230 include discharge parts 230a which contribute to discharge, and connecting parts 230b which connect the discharge parts 230a to each other.

The second electrodes 230 extend across the substrate 210 and are substantially parallel to each other. As illustrated in FIG. 2, the second electrodes 230 may extend in the same direction as the direction in which the first electrodes 220 extend. Alternatively, the second electrodes 230 may extend in a direction other than the direction in which the first electrodes 220 extend, for example, in a direction perpendicular to the direction in which the first electrodes 220 extend. The second electrodes 230 are arranged on the substrate 210 so that areas of the substrate 210 which are surrounded by the discharge parts 230a correspond to the apertures 210a of the substrate 210.

Similar to the first electrodes 220, each of the second electrodes 230 may be a single layer including a conductive material. However, similar to the first electrodes 220, each of the second electrodes 230 may include a second plated seed film 231 formed on the substrate 210 and a second plated layer 232 formed on the second plated seed film 231, the second plated layer 232 including a material used to form the second electrodes 230.

Similar to the first plated seed film 221, the second plated seed film 231 serving as a seed of the formation of the second plated layer 232 on the substrate 210 may be formed of a material which can be easily coated on the flexible substrate 210, such as a polyethersulfone resin or polyimide film.

Similar to the first plated layer 222, the second plated layer 232 may be formed of the material of the second electrodes 230, such as a material with which the second plated seed film 231 can be easily plated.

The second plated seed film 231 and the second plated layer 232 may be an electroless seed film and an electroless plated layer, respectively.

The second electrodes 230 are covered with the second insulation layer 250. The second insulation layer 250 may be formed either on the entire surface of the substrate 210 except for the apertures 210a while covering the second electrodes 230, or on only parts of the surface of the substrate 210 which correspond to the second electrodes 230.

Similar to the first insulation layer 240, the second insulation layer 250 may be formed of various insulation materials, for example, a flexible and insulation material such as, polyethersulfone resin or polyimide. When the second insulation layer 250 is formed of an insulation and flexible material, that is, the material used to form the substrate 210, as described above, the flexibility of the panel for plasma display of FIG. 2 increases. Moreover, since the second insulation layer 250 is formed of the material used to form the substrate 210, the flexibility of the second insulation layer 250 is consistent with that of the substrate 210. Accordingly, portions of the second insulation layer 250 and the substrate 210 which contact each other are prevented from cracking.

Since the panel for plasma display having this structure is flexible, it operates even when it is bent as illustrated in FIG. 2.

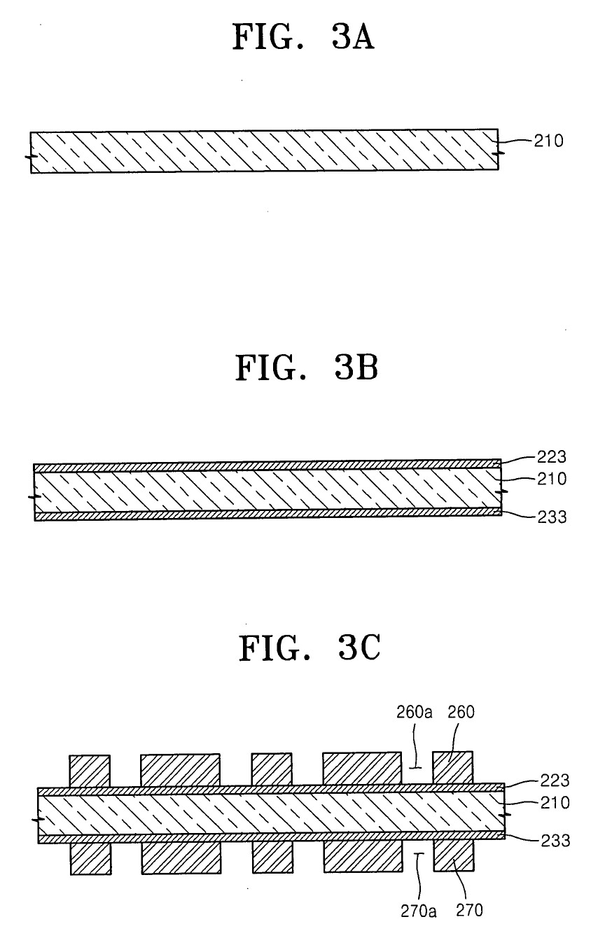

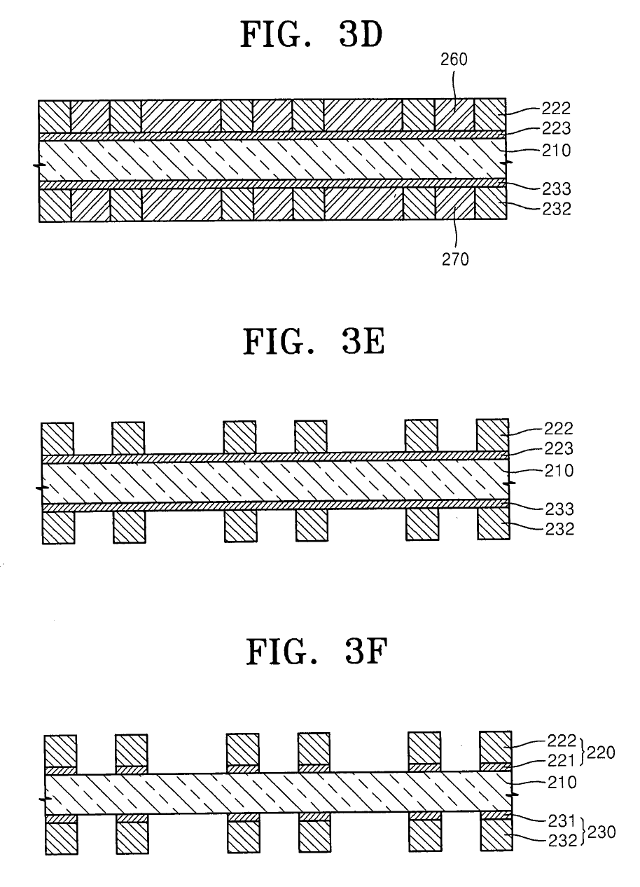

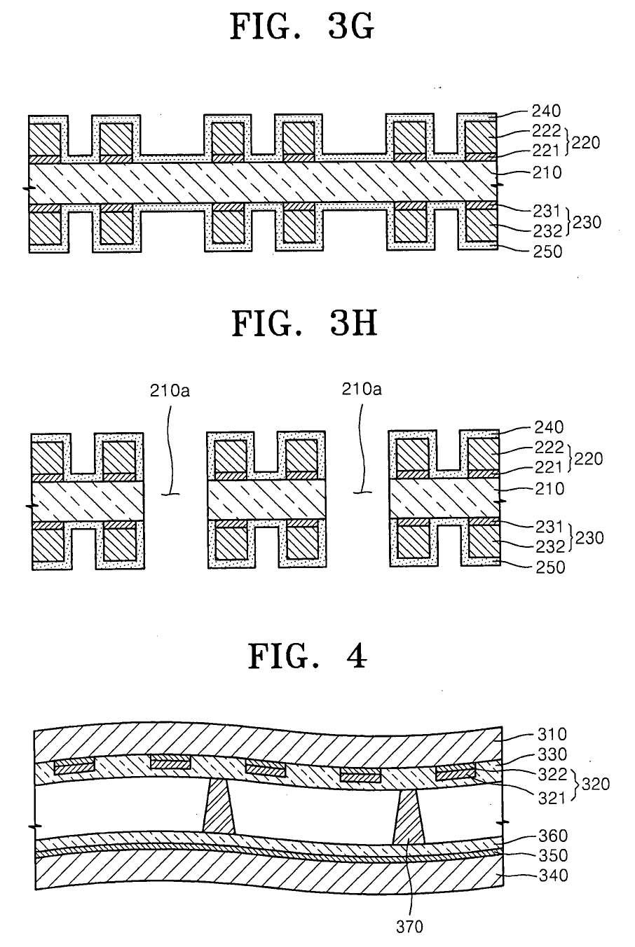

FIGS. 3A thru 3H are cross-sectional views illustrating a method of manufacturing the panel for plasma display shown in FIG. 2.

The manufacturing method includes an operation (shown in FIG. 3A) of preparing for the flexible substrate 210 and operations (shown in FIGS. 3B-3H) of arranging the first electrodes 220 and the second electrodes 230 on both sides of the substrate 210.

As illustrated in FIG. 3A, a film formed of a material including one of polyethersulfone resin and polyimide is prepared to serve as the flexible substrate 210.

As illustrated in FIG. 3B, the substrate 210 is soaked in a solution including palladium, thereby forming a palladium material 223 for the first plated seed film 221 and a palladium material 233 for the second plated seed film 231 on respective sides of the substrate 210.

As illustrated in FIG. 3C, a first photoresist pattern 260 corresponding to the pattern of the first electrodes 220 and a second photoresist pattern 270 corresponding to the pattern of the second electrodes 230 are formed on the palladium material 223 for the first plated seed film 221 and the palladium material 233 for the second plated seed film 231, respectively.

The first photoresist pattern 260 may be formed by coating the first plated seed film material 223 with a photoresist film, photo-exposing the photoresist film using a photomask having a pattern corresponding to the pattern of the first electrodes 220, and developing the photoresist film using a developing solution.

The second photoresist pattern 270 may be formed on the second plated seed film material 233 according to the same method as the method of forming the first photoresist pattern 260.

The first photoresist pattern 260 and second photoresist pattern 270 formed in this manner have apertures 260a corresponding to the first electrodes 220 and apertures 270a corresponding to the second electrodes 230, respectively.

As illustrated in FIG. 3D, the substrate 210 having the first photoresist patters 260 and second photoresist pattern 270 formed thereon is soaked in a plating solution including a material used to form the first electrodes 220 and second electrodes 230, such as copper, whereby the first plated layers 222 are first formed on portions of the first plated seed film material 223 which are exposed through the apertures 260a of the first photoresist pattern 260, and then the second plated layers 232 are formed on portions of the second plated seed film material 233 which are exposed through the apertures 270a of the second photoresist pattern 270.

As illustrated in FIG. 3E, the first photoresist pattern 260 and second photoresist pattern 270 are removed using a chemical solution or O₂ plasma.

As illustrated in FIG. 3F, first, the first plated seed film material 223 is removed using the first plated layers 222 as a mask by soft etching, such as dry etching, thereby forming the first plated seed films 221. Then, the second plated seed film material 233 is removed using the second plated layers 232 as a mask by soft etching, such as dry etching, thereby forming the second plated seed films 231. As a result, the first electrodes 220 and the second electrodes 230 are completely formed.

As illustrated in FIG. 3G, the first insulation layer 240 covering the first electrodes 220 and the second insulation layer 250 covering the second electrodes 230 are formed on the sides of the substrate 210 on which the first electrodes 220 and second electrodes 230, respectively, are formed.

As illustrated in FIG. 3H, the resultant substrate 210 undergoes etching using a chemical solution or the like, whereby the apertures 210a through which the insides of the discharge parts of the first electrodes 220 are connected to those of the discharge parts of the second electrodes 230 are formed in the substrate 210.

A flexible panel can be easily manufactured according to the method illustrated in FIGS. 3A thru 3H.

Although the first electrodes 220 and second electrodes 230 are formed using an electroless plating technique in the embodiment of FIGS. 3A thru 3H, they may be formed according to various other techniques, such as an electrolytic plating technique or a deposition technique.

FIG. 4 is a partial cross-section view of a plasma display panel according to an embodiment of the present invention.

The plasma display panel includes a first substrate 310, a plurality of first electrodes 320, each including a first plated seed film 321 and a first plated layer 322, a first insulation layer 330, a second substrate 340, a plurality of second electrodes 350, a second insulation layer 360, and a plurality of barrier ribs 370.

The first substrate 310, the first electrodes 320 including the first plated seed films 321 and the first plated layers 322, and the first insulation layer 330 correspond to the substrate 110, the electrodes 120 including the plated seed films 121 and the plated layers 122, and the insulation layer 130 illustrated in FIG. 1. Therefore, they will not be described in further detail herein.

The second substrate 340 is disposed opposite to the side of the first substrate 310 on which the electrodes 120 and the insulation layer 130 are formed. The second substrate 340 may be flexible. To be flexible, the second substrate 340 may either be formed of a material including at least one of polyethersulfone resin and polyimide, or be formed of a material including an organic material. The second substrate 340 may also be formed of the same material as the material used to form the first substrate 310.

The second electrodes 350, intersecting the first electrodes 320, are arranged on a surface of the second substrate 340 which faces the first substrate 310. Portions of the second electrodes 350 which cross the first electrodes 320 may cause discharge.

The second electrodes 350 may be formed according to the same method as the method of forming the first electrodes 220 during the manufacture of the panel for plasma display illustrated in FIGS. 3A thru 3H.

The second insulation layer 360 maybe further formed on the second electrodes 350. The second insulation layer 360 may be formed of a flexible material, such as a material including at least one of polyethersulfone resin and polyimide. Moreover, the second insulation layer 360 may be formed of the material used to form the second substrate 340.

The barrier ribs 370, partitioning the space between the first and second substrates 310 and 340 into a plurality of discharge cells where discharge occurs, may be further formed on the second insulation layer 360.

The barrier ribs 370 partition the space between the first and second substrates 310 and 340 into the discharge cells, a single second electrode 350 crossing a pair of first electrodes 320 in each discharge cell.

Since the plasma display panel having this structure is flexible, it can operate even when it is bent.

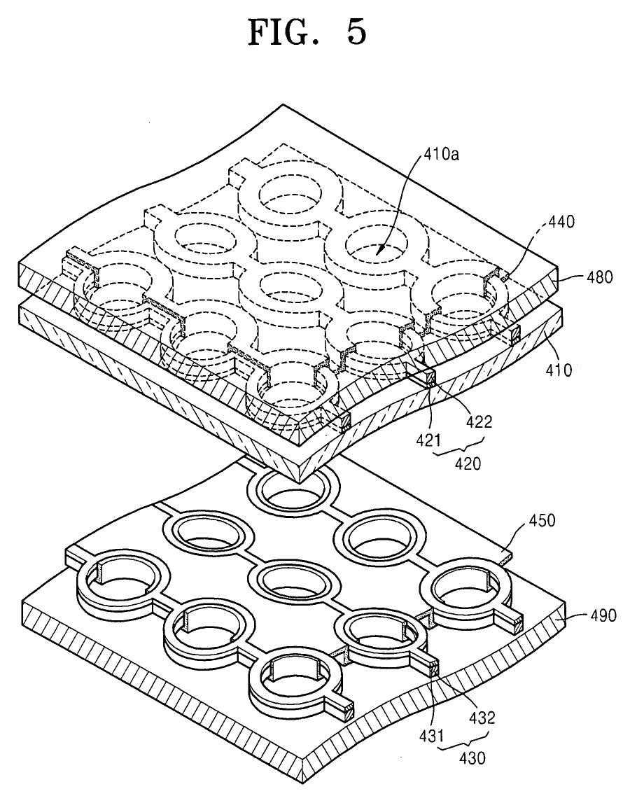

FIG. 5 is a partial cross-section view of a plasma display panel according to another embodiment of the present invention. The plasma display panel includes a first substrate 410, a plurality of first electrodes 420, each including a first plated seed film 421 and a first plated layer 422, a plurality of second electrodes 430, each including a second plated seed film 431 and a second plated layer 432, a first insulation layer 440, a second insulation layer 450, a second substrate 4850, and a third substrate 490.

The first substrate 410, the first electrodes 420, the second electrodes 430, the first insulation layer 440, and the second insulation layer 450 correspond to the substrate 210, the first electrodes 220, the second electrodes 230, the first insulation layer 240, and the second insulation layer 250, respectively, illustrated in FIG. 2. Therefore, they will not be described in further detail herein.

The second substrate 480 is disposed on the first insulation layer 440 of the first substrate 410. The second substrate 480 covers the first electrodes 420 and the first insulation layer 440 of the first substrate 410. The second substrate 480 may be formed of a flexible material, namely, a material including at least one of polyethersulfone resin and polyimide. The second substrate 480 may also be formed of the same material as the material used to form the first substrate 410.

The third substrate 490 is disposed on the second insulation layer 450 of the first substrate 410. The third substrate 490 covers the second electrodes 430 and the second insulation layer 450 of the first substrate 410.

The third substrate 490 may be formed of a flexible material, namely, a material including at least one of polyethersulfone resin and polyimide. The third substrate 490 may also be formed of the same material as the material used to form the first substrate 410.

The second substrate 480 and third substrate 490, together with the first insulation layer and second insulation layer 450, define a plurality of discharge cells wherein discharge occurs near apertures 410a of the first substrate 410.

Since the plasma display panel having this structure is flexible, it can operate even when it is bent.

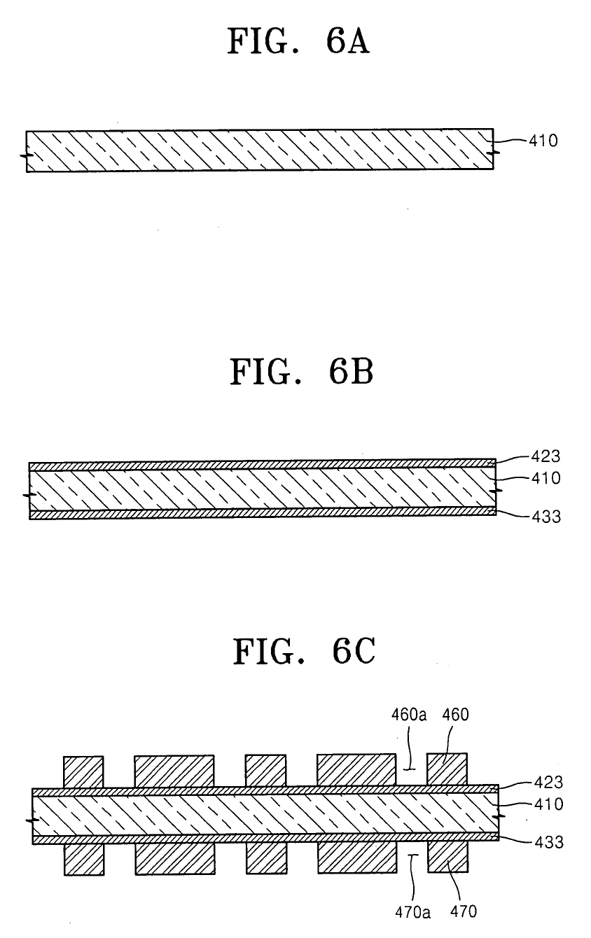

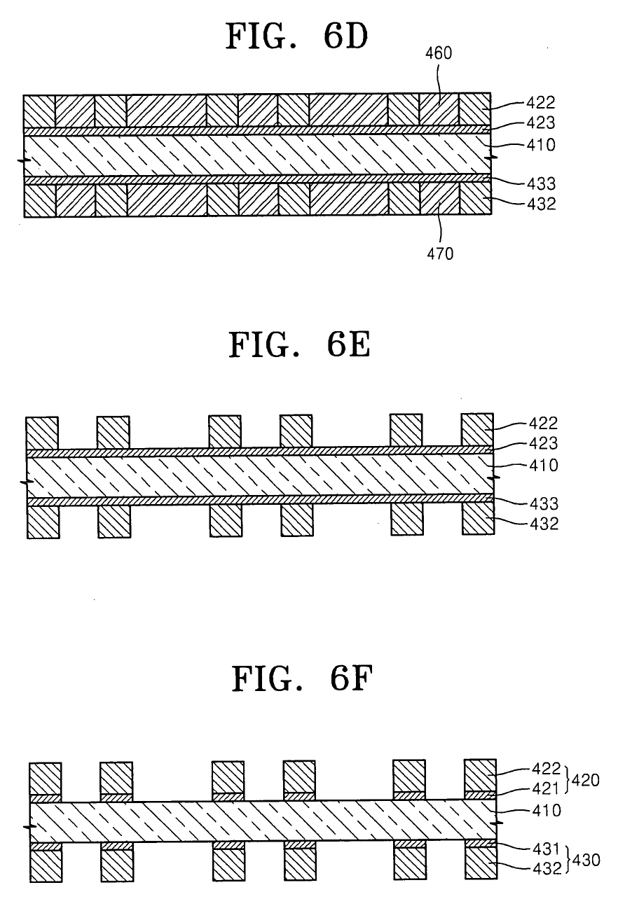

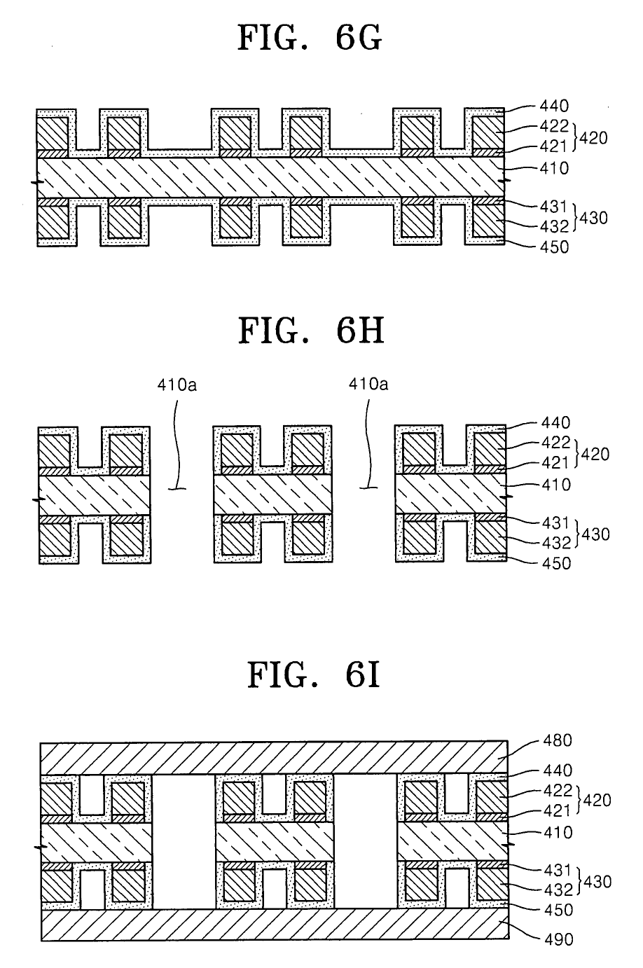

FIGS. 6A thru 6I are cross-sectional views illustrating a method of manufacturing the plasma display panel shown in FIG. 5.

The manufacturing method includes an operation (shown in FIG. 6A) of preparing for the first flexible substrate 410, operations (shown in FIGS. 6B-6H) of arranging the first electrodes 420 and the second electrodes 430 on both sides of the first substrate 410, and an operation (shown in FIG. 6I) of arranging the second substrate 480 and third substrate 490.

The operations illustrated in FIGS. 6A thru 6H correspond to the operations illustrated in FIGS. 3A thru 3H, respectively. Therefore, they will not be described in greater detail herein.

As illustrated in FIG. 6I, the second substrate 480 is disposed on the first insulation layer 440 of the first substrate 410. The second substrate 480 covers the first electrodes 420 and the first insulation layer 440 of the first substrate 410. The second substrate 480 may be formed of a flexible material, namely, a material including at least one of polyethersulfone resin and polyimide. The second substrate 480 may also be formed of the same material as the material used to form the first substrate 410.

The third substrate 490 is disposed on the second insulation layer 450 of the first substrate 410. The third substrate 490 covers the second electrodes 430 and the second insulation layer 450 of the first substrate 410.

The third substrate 490 may be formed of a flexible material, namely, a material including at least one of polyethersulfone resin and polyimide. The third substrate 490 may also be formed of the same material as the material used to form the first substrate 410.

The second substrate 480 and third substrate 490, together with the first insulation layer 440 and second insulation layer 450, define a plurality of discharge cells wherein discharge occurs near the apertures 410a of the first substrate 410.

A flexible plasma display panel can be easily manufactured according to the method illustrated in FIGS. 6A thru 6I.

The present invention provides a flexible panel for plasma display, a method of manufacturing the flexible panel, a plasma display panel including the flexible panel, and a method of manufacturing the plasma display panel. Accordingly, the plasma display panel can operate even when it has been bent.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A panel for plasma display, comprising:
a substrate which is flexible; and
a plurality of electrodes arranged on at least one surface of the substrate.

2. The panel for plasma display of claim 1, wherein the substrate is formed of a material comprising at least one of polyethersulfone resin and polyimide.

3. The panel for plasma display of claim 1, wherein the substrate is formed of a material comprising an organic material.

4. The panel for plasma display of claim 1, wherein the thickness of the substrate is not greater than 2.8 mm.

5. The panel for plasma display of claim 1, wherein the substrate transmits light.

6. The panel for plasma display of claim 1, wherein each of the electrodes comprises a plated seed film and a plated layer which is formed on the plated seed film, and further comprises a material used to form the electrodes.

7. The panel for plasma display of claim 1, wherein the electrodes are arranged on both surfaces of the substrate.

8. The panel for plasma display of claim 7, wherein apertures are formed in portions of the substrate which are not covered with the electrodes.

9. The panel for plasma display of claim 1, further comprising an insulation layer with which the electrodes are covered.

10. A method of manufacturing a panel for plasma display, comprising the steps of:
preparing a substrate which is flexible; and
arranging a plurality of electrodes on at least one surface of the substrate.

11. The method of claim 10, wherein the substrate is formed of a material comprising at least one of polyethersulfone resin and polyimide.

12. The method of claim 10, wherein the step of arranging the electrodes comprises:
forming a plated seed film on at least one surface of the substrate;
arranging a mask, having apertures corresponding to the electrodes, on the plated seed film;
forming plated layers on portions of the plated seed films which are exposed through the apertures of the mask, each of the plated layers comprising a material used to form the electrodes;
removing the mask and plated layers formed on the mask from the plated seed film; and
removing portions of the plated seed film which are not covered with the plated layers so as to form the plurality of electrodes.

13. The method of claim 12, wherein the portions of the plated seed film which are not covered with the plated layers are removed by etching.

14. The method of claim 10, further comprising forming an insulation layer with which the electrodes are covered.

15. The method of claim 10, wherein the electrodes are arranged on both surfaces of the substrate.

16. The method of claim 15, further comprising the step of forming apertures in portions of the substrate which are not covered with the electrodes.

17. A plasma display panel, comprising:
a first substrate which is flexible;
a plurality of first electrodes arranged on one surface of the first substrate;
an insulation layer with which the first electrodes are covered; and
a second substrate facing the surface of the first substrate on which the first electrodes are arranged.

18. The plasma display panel of claim 17, wherein the first substrate is formed of a material comprising at least one of polyethersulfone resin and polyimide.

19. The plasma display panel of claim 17, wherein the second substrate is flexible and is formed of a material comprising at least one of polyethersulfone resin and polyimide.

20. The plasma display panel of claim 17, wherein the thickness of each of the first and second substrates is not greater than 2.8 mm.

21. The plasma display panel of claim 17, wherein the first substrate transmits light.

22. The plasma display panel of claim 17, wherein each of the first electrodes comprises a plated seed film and a plated layer which is formed on the plated seed film, and further comprises a material used to form the first electrodes.

23. The plasma display panel of claim 17, further comprising a plurality of barrier ribs which partition the space between the first and second substrates into a plurality of discharge cells wherein gas discharge is generated.

24. The plasma display panel of claim 23, further comprising a plurality of second electrodes which are arranged on the second substrate and which intersect the first electrodes.

25. A plasma display panel, comprising:
a first substrate which is flexible;
a plurality of first electrodes arranged on one surface of the first substrate;
a plurality of second electrodes arranged on another surface of the first substrate;
a first insulation layer with which the first electrodes are covered;
a second insulation layer with which the second electrodes are covered; and
a second substrate and a third substrate facing each other, the first substrate, the first and second electrodes and the first and second insulation layers being located between the second substrate and the third substrate;
wherein apertures are formed in portions of the first substrate which are not covered with the first and second electrodes.

26. The plasma display panel of claim 25, wherein the first substrate is formed of a material comprising at least one of polyethersulfone resin and polyimide.

27. The plasma display panel of claim 25, wherein the second and third substrates are flexible and are each formed of a material comprising at least one of polyethersulfone resin and polyimide.

28. The plasma display panel of claim 25, wherein the first and second electrodes comprise plated seed films and plated layers which are formed on the plated seed films, the plated layers comprising materials used to form the first electrodes.

29. The plasma display panel of claim 25, further comprising a plurality of third electrodes which are arranged between the first and second substrates and which intersect at least one of the first electrodes and the second electrodes.

30. A method of manufacturing a plasma display panel, comprising the steps of:
preparing a first substrate which is flexible;
arranging a plurality of electrodes on at least one surface of the first substrate;
forming an insulation layer with which the electrodes are covered; and
arranging at least one second substrate directly over the surface of the first substrate on which the electrodes are formed.

31. The method of claim 30, wherein the first substrate is formed of a material comprising at least one of polyethersulfone resin and polyimide.

32. The method of claim 30, wherein said at least one second substrate is flexible and is formed of a material comprising at least one of polyethersulfone resin and polyimide.

33. The method of claim 30, wherein the step of arranging of the electrodes comprises:
forming a plated seed film on at least one surface of the substrate;
arranging a mask, having apertures corresponding to the electrodes, on the plated seed film;
forming plated layers on portions of the plated seed films which are exposed through the apertures of the mask, wherein each of the plated layers comprises a material used to form the electrodes;
removing the mask and plated layers formed on the mask from the plated seed film; and
removing portions of the plated seed film which are not covered with the plated layers so as to form the plurality of electrodes.

34. The method of claim 33, wherein the portions of the plated seed film which are not covered with the plated layers are removed by etching.
